(19) United States
(12) Patent Application Publication
(10) Pub. No.: US 2026/0147347 A1
(43) Pub. Date: May 28, 2026

(54) INFORMATION PROCESSING METHOD, RECORDING MEDIUM, AND INFORMATION PROCESSING SYSTEM

(71) Applicant: Panasonic Intellectual Property Management Co., Ltd., Osaka (JP)

(72) Inventors: Kotaro SAKATA, Osaka (JP); Tetsuji FUCHIKAMI, Osaka (JP)

(21) Appl. No.: 19/453,555

(22) Filed: Jan. 20, 2026

Related U.S. Application Data
(63) Continuation of application No. PCT/JP2024/024034, filed on Jul. 3, 2024.

(30) Foreign Application Priority Data
Aug. 2, 2023 (JP) 2023-126324

(51) Int. Cl. G05D 1/242; B25J 9/16; G05D 1/46; G05D 109/20

(52) U.S. Cl. CPC G05D 1/2427; B25J 9/1664; G05D 1/46; G05D 2109/20

(57) ABSTRACT

An information processing method executed by a computer includes: acquiring user information including a position of a user; acquiring robot information including a position of at least one robot; identifying at least one candidate robot based on the user information acquired and the robot information acquired, where the at least one candidate robot is a candidate to which the user is to pay attention; and outputting notification information including at least one of information prompting attention to the at least one candidate robot identified, information indicating a position of the at least one candidate robot, or information indicating a movement of the at least one candidate robot.

### CROSS REFERENCE TO RELATED APPLICATIONS

This is a continuation application of PCT International Application No. PCT/JP 2024/024034 filed on Jul. 3, 2024, designating the United States of America, which is based on and claims priority of Japanese Patent Application No. 2023-126324 filed on Aug. 2, 2023. The entire disclosures of the above-identified applications, including the specifications, drawings and claims are incorporated herein by reference in their entirety.

### DESCRIPTION

### Field

The present disclosure relates to information processing methods, programs, and information processing systems for presenting robot related information to users.

### Background

Patent Literature (PTL) 1 discloses a control method for a mobile robot that travels autonomously.

### CITATION LIST

### Patent Literature

PTL 1: Japanese Unexamined Patent Application Publication No. 2019-133450

### SUMMARY

### Technical Problem

The present disclosure provides an information processing method or the like that enables a user to readily ascertain information about a robot that may be a target of the user's attention.

### Solution to Problem

An information processing method according to an aspect of the present disclosure is executed by a computer and includes: acquiring user information including a position of a user; acquiring robot information including a position of at least one robot; identifying at least one candidate robot based on the user information acquired and the robot information acquired, where the at least one candidate robot is a candidate to which the user is to pay attention; and outputting notification information including at least one of information prompting attention to the at least one candidate robot identified, information indicating a position of the at least one candidate robot, or information indicating a movement of the at least one candidate robot.

A program according to an aspect of the present disclosure causes a computer to execute the aforementioned information processing method.

An information processing system according to an aspect of the present disclosure includes a first acquirer, a second acquirer, an identifier, and an output unit. The first acquirer acquires user information including a position of a user. The second acquirer acquires robot information including a position of at least one robot. The identifier identifies at least one candidate robot based on the user information acquired by the first acquirer and the robot information acquired by the second acquirer, where the at least one candidate robot is a candidate to which the user is to pay attention. The output unit outputs notification information including at least one of information prompting attention to the at least one candidate robot identified by the identifier, information indicating a position of the at least one candidate robot, or information indicating a movement of the at least one candidate robot.

These general or specific aspects may be implemented using a system, a device, a method, an integrated circuit, a computer program, or a non-transitory computer readable recording medium, such as a compact disc-read only memory (CD-ROM), or may be implemented using any combination of systems, devices, methods, integrated circuits, computer programs, and recording media.

### Advantageous Effects

The present disclosure is advantageous in enabling a user to readily ascertain information about a robot that may be a target of the user's attention.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating the overall configuration including an information processing system according to an embodiment.

FIG. 2 is a schematic diagram illustrating an example of a third robot.

FIG. 3 is a schematic diagram illustrating an example of a process for identifying at least one candidate robot.

FIG. 4 is a schematic diagram illustrating another example of the process for identifying at least one candidate robot.

FIG. 5 is a schematic diagram illustrating an example of a process for determining at least one zone.

FIG. 6 is a schematic diagram illustrating a first example of notification information presented on a presentation device.

FIG. 7 is a schematic diagram illustrating a second example of notification information presented on the presentation device.

FIG. 8 is a schematic diagram illustrating a third example of notification information presented on the presentation device.

FIG. 9 is a flowchart illustrating a basic operation example of the information processing system according to the embodiment.

### DESCRIPTION OF EMBODIMENTS

In light of the declining trend or the like in the number of workers engaged in work at worksites (e.g., carpenters engaged in construction work at construction sites) in recent years, various robots that perform work in place of workers are being introduced to worksites. In such worksites where robots are introduced, since workers and robots coexist, smooth positioning is required to prevent the workers and the robots from interfering with each other.

When there is a second worker near a first worker, the first worker can readily ascertain whether the second worker may interfere with the first worker by viewing the facial expression, movement, or the like of the second worker. In this case, supposing that the second worker appears likely to interfere with the first worker, interference with the first worker can be readily avoided by alerting the second worker. In other words, when the second worker is near the first worker, the first worker does not feel particularly uneasy toward the second worker.

On the other hand, when there is a robot near a worker, the worker finds it difficult to ascertain whether the robot may interfere with the worker even by seeing the robot. In this case, supposing that the robot appears likely to interfere with the worker, the worker cannot alert the robot and therefore needs to take measures, such as moving away from the robot. In other words, when there is a robot nearby, the worker tends to feel uneasy toward the robot.

In view of this, for example, a conceivable method involves displaying information about all robots (e.g., movement directions of the robots) present around a worker on a display of smart glasses worn by the worker, so that the worker can readily pay attention to the robots. With this method, however, since the information about all the robots present around the worker is displayed on the display, the amount of information tends to become excessive for the worker. This is problematic in that the worker may find it difficult to ascertain information about a robot that may be a target of attention.

The present disclosure provides an information processing method or the like that enables a user (worker) to readily ascertain information about a robot that may be a target of the user's attention.

More specifically, an information processing method according to a first aspect of the present disclosure is executed by a computer and includes: acquiring user information including a position of a user; acquiring robot information including a position of at least one robot; identifying at least one candidate robot based on the user information acquired and the robot information acquired, where the at least one candidate robot is a candidate to which the user is to pay attention; and outputting notification information including at least one of information prompting attention to the at least one candidate robot identified, information indicating a position of the at least one candidate robot, or information indicating a movement of the at least one candidate robot.

This is advantageous in that, since only information about at least one candidate robot is presented to the user instead of information about all robots present around the user, the user can readily ascertain information about a robot (at least one candidate robot) that may be a target of the user's attention.

Furthermore, for example, the information processing method according to a second aspect of the present disclosure is the information processing method according to the first aspect in which, the information indicating the movement of the at least one candidate robot includes at least one of a movement direction or a movement path of the at least one candidate robot.

This is advantageous in that, since information indicating how the robot that may be a target of the user's attention moves can be presented to the user, the user can pay attention to the relevant robot more readily.

Furthermore, for example, the information processing method according to a third aspect of the present disclosure is the information processing method according to the first or second aspect in which, the identifying of the at least one candidate robot includes: determining at least one zone with reference to the position of the user; and identifying, as the at least one candidate robot, a robot present in the at least one zone determined.

This is advantageous in that, since only a robot present in at least one zone is identified as a candidate robot, the user can ascertain information about the robot, which may be a target of the user's attention, more readily.

Furthermore, for example, the information processing method according to a fourth aspect of the present disclosure is the information processing method according to any one of the first to third aspects in which, the acquiring of the robot information includes further acquiring behavior information indicating a behavior of the at least one robot, and, in the identifying of the at least one candidate robot, the at least one candidate robot is identified further based on the behavior information acquired.

This is advantageous in that, since at least one candidate robot can be identified sooner than when at least one candidate robot is identified based on user information alone, the user can quickly and readily ascertain information about a robot that may be a target of the user's attention.

Furthermore, for example, the information processing method according to a fifth aspect of the present disclosure is the information processing method according to the third aspect in which, the acquiring of the user information includes further acquiring posture information indicating a posture of the user, and, in the identifying of the at least one candidate robot, the at least one zone is determined further based on the posture information acquired.

This is advantageous in that, since at least one zone can be determined sooner than when at least one zone is determined based on user information alone, the user can quickly and readily ascertain information about a robot that may be a target of the user's attention.

Furthermore, for example, the information processing method according to a sixth aspect of the present disclosure is the information processing method according to the third or fourth aspect in which, the acquiring of the user information includes further acquiring directional information indicating at least one of a direction of a face or a direction of a line of sight of the user, and, in the identifying of the at least one candidate robot, the at least one zone is determined further based on the directional information acquired.

This is advantageous in that, since a robot that cannot be captured when at least one zone is determined based on user information alone can be identified as a candidate robot, the robot, which may be a target of the user's attention, can be identified readily and accurately.

Furthermore, for example, the information processing method according to a seventh aspect of the present disclosure is the information processing method according to any one of the first to sixth aspects in which, the at least one robot includes an autonomous flying robot. The acquiring of the robot information includes further acquiring height information indicating a height of the autonomous flying robot, and, in the identifying of the at least one candidate robot, the at least one candidate robot is identified further based on the height information acquired.

This is advantageous in that, since a candidate robot can be identified in view of the height of the autonomous flying robot (second robot), the robot, which may be a target of the user's attention, can be identified readily and accurately.

Furthermore, for example, the information processing method according to an eighth aspect of the present disclosure is the information processing method according to any one of the first to seventh aspects in which, the at least one robot includes a robot including a manipulator. The acquiring of the robot information includes further acquiring movable range information indicating a movable range of the manipulator, and, in the identifying of the at least one candidate robot, the at least one candidate robot is identified further based on the movable range information acquired.

This is advantageous in that, since a candidate robot can be identified in view of the movable range of the manipulator of the robot (third robot) including the manipulator, the robot, which may be a target of the user's attention, can be identified readily and accurately.

Furthermore, for example, the information processing method according to a ninth aspect of the present disclosure is the information processing method according to any one of the first to eighth aspects in which, in the outputting of the notification information, the notification information is output to smart glasses worn by the user.

This is advantageous in that, since notification information can be displayed over the visual field of the user in a superimposed fashion on the display of the smart glasses, the user can readily ascertain information about a robot, which may be a target of the user's attention, while viewing the real space.

Furthermore, for example, a program according to a tenth aspect of the present disclosure causes a computer to execute the information processing method according to any one of the first to ninth aspects.

This is advantageous in that advantageous effects similar to those of the information processing method described above can be exhibited.

Furthermore, for example, an information processing system according to an eleventh aspect of the present disclosure includes a first acquirer, a second acquirer, an identifier, and an output unit. The first acquirer acquires user information including a position of a user. The second acquirer acquires robot information including a position of at least one robot. The identifier identifies at least one candidate robot based on the user information acquired by the first acquirer and the robot information acquired by the second acquirer, where the at least one candidate robot is a candidate to which the user is to pay attention. The output unit outputs notification information including at least one of information prompting attention to the at least one candidate robot identified by the identifier, information indicating a position of the at least one candidate robot, or information indicating a movement of the at least one candidate robot.

This is advantageous in that advantageous effects similar to those of the information processing method described above can be exhibited.

Furthermore, for example, the information processing system according to a twelfth aspect of the present disclosure is the information processing system according to the eleventh aspect further including a presentation device. The presentation device includes a communicator and a presenter, where the communicator receives the notification information output by the output unit and the presenter presents, to the user, the notification information received by the communicator.

This is advantageous in that advantageous effects similar to those of the information processing method described above can be exhibited.

Furthermore, these general or specific aspects may be implemented using a system, a device, a method, an integrated circuit, a computer program, or a non-transitory computer readable recording medium, such as a CD-ROM, or may be implemented using any combination of systems, devices, methods, integrated circuits, computer programs, and recording media.

Embodiments will be described in detail below with reference to the drawings. The embodiments to be described below indicate general or specific examples. Numerical values, shapes, materials, elements, positions and connection methods of the elements, steps, the order of the steps, and so on indicated in the embodiments below are examples, and are not intended to limit the present disclosure. Among the elements in the embodiments below, those not recited in any one of the independent claims are described as optional elements. Each drawing is schematic and is not necessarily an exact illustration. In the drawings, same reference signs are given to substantially identical components, and redundant descriptions may sometimes be omitted or simplified.

### Embodiment

### 1. Configuration

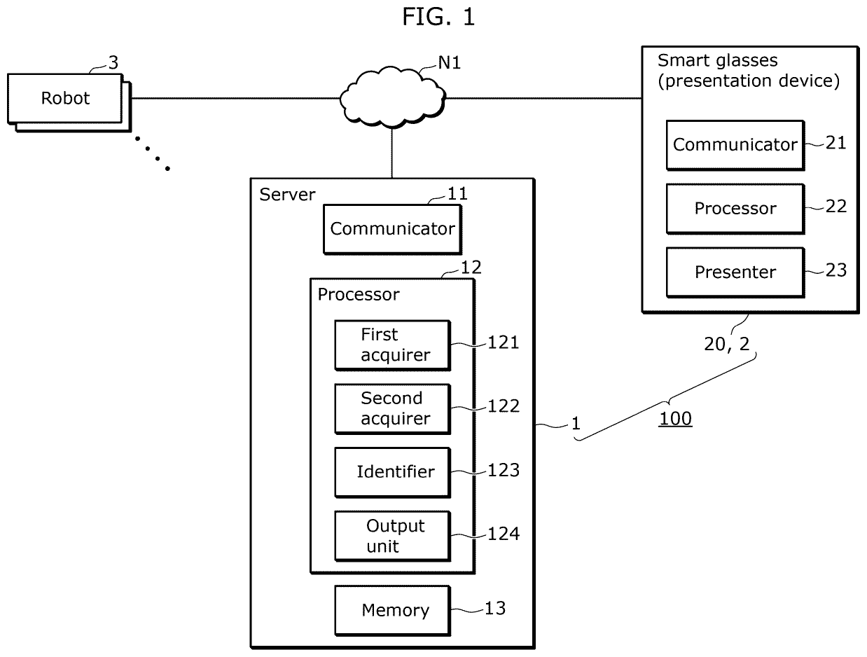

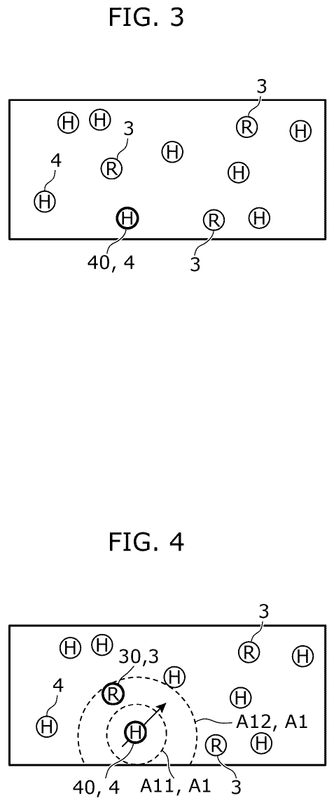

First, the overall configuration including an information processing system according to an embodiment will be described. FIG. 1 is a block diagram illustrating the overall configuration including the information processing system according to the embodiment. As illustrated in FIG. 1, information processing system 100 according to the embodiment includes server 1 and presentation device 2. In the embodiment, presentation device 2 is a pair of smart glasses 20 worn by user 40 (see FIG. 3) who is one of one or more workers 4 present at a worksite. Information processing system 100 does not have to include smart glasses 20 (presentation device 2) so long as information processing system 100 includes server 1.

In the embodiment, the worksite is a space in which one or more workers 4 (in this case, multiple workers 4) including user 40 and one or more robots 3 (in this case, multiple robots 3) each perform work, and is a space where one or more workers 4 and one or more robots 3 coexist (see FIG. 3).

Each robot 3 autonomously executes the same work as the work performed by each worker 4 at the worksite. Each robot 3 includes a wireless communication interface for wirelessly communicating with server 1 via network N1, such as the Internet or a wireless local area network (LAN).

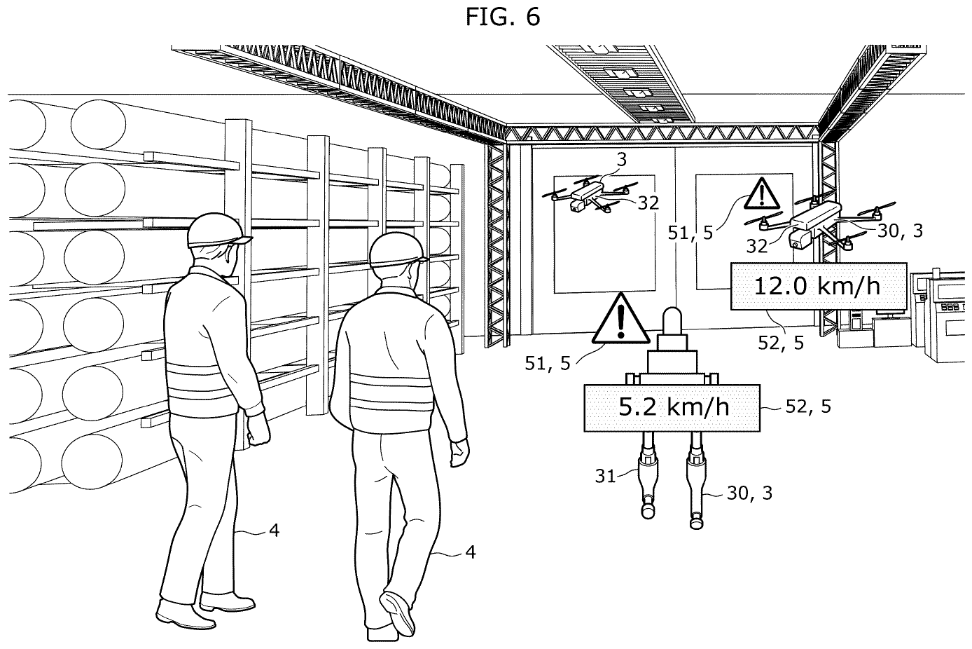

Robots 3 may include an autonomous flying robot (see second robot 32 to be described later and illustrated in FIG. 6 and the like), such as a drone, which performs an indoor inspection operation at the worksite. Moreover, robots 3 may include an autonomous mobile robot (see first robot 31 to be described later and illustrated in FIG. 6 and the like) that performs a photographing operation at the worksite, a remote monitoring operation at the worksite, an automatic patrol operation at the worksite, or the like. An autonomous mobile robot may include a walking robot that walks with multiple legs, a traveling robot that travels with multiple wheels, or the like.

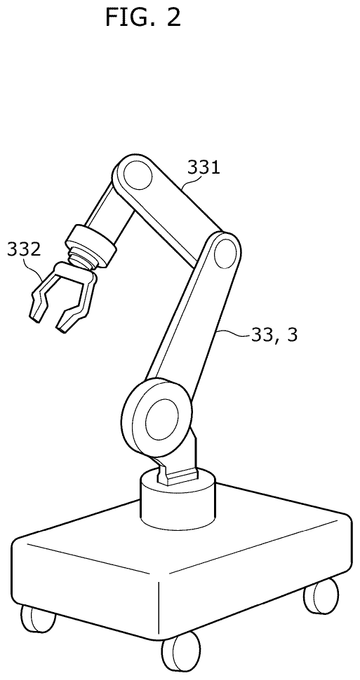

As illustrated in FIG. 2, robots 3 may include, for example, third robot 33 including a manipulator that performs the same work as the manual work performed by each worker 4 at the worksite. FIG. 2 is a schematic diagram illustrating an example of third robot 33. In the example illustrated in FIG. 2, third robot 33 is a traveling robot that travels with multiple wheels. Furthermore, in the example illustrated in FIG. 2, third robot 33 includes, as a manipulator, movable robot arm 331 and robot hand 332 provided at the distal end of robot arm 331.

Third robot 33 may be movable using another travel mode different from the multiple wheels, or may be fixed to the worksite. Third robot 33 may include multiple robot arms 331. Third robot 33 does not have to include robot hand 332.

The pair of smart glasses 20 is an eyeglass-type wearable terminal and is a pair of so-called augmented reality (AR) glasses. In the embodiment, the pair of smart glasses 20 is worn over both eyes of user 40, but may alternatively be worn over one of the eyes of user 40. As illustrated in FIG. 1, the pair of smart glasses 20 (presentation device 2) includes communicator 21, processor 22, and presenter 23.

Communicator 21 is a wireless communication interface for communicating with server 1. Communicator 21 wirelessly communicates with server 1 via network N1, so as to transmit various types of information to server 1 and/or to receive various types of information from server 1. In the embodiment, communicator 21 receives notification information (to be described later) output by output unit 124 (to be described later) of server 1.

Processor 22 includes, for example, a processor and a memory, and causes the processor to execute a program stored in the memory, so as to exhibit various types of functions included in smart glasses 20.

Presenter 23 presents, to user 40, the notification information received by communicator 21. In the embodiment, presenter 23 is a transmissive display provided in smart glasses 20, and transmits ambient light. Thus, user 40 can view the real space through presenter 23. Notification object 5 (see FIG. 6) indicating the notification information is displayed over the visual field of user 40 on presenter 23 in a superimposed fashion. Thus, user 40 can view notification object 5, such as an image and/or text, not present in the real space together with the real space.

Server 1 is disposed at the worksite or a location away from the worksite, and is communicable with smart glasses 20 and one or more robots 3 via network N1. Although server 1 is communicable with one pair of smart glasses 20 in the example illustrated in FIG. 1, if there are multiple users 40, server 1 may be individually communicable with multiple pairs of smart glasses 20 worn by multiple users 40. As illustrated in FIG. 1, server 1 includes communicator 11, processor 12, and memory 13.

Communicator 11 is a wireless communication interface for communicating with presentation device 2 (smart glasses 20) and one or more robots 3. Communicator 11 wirelessly communicates with presentation device 2 via network N1, so as to transmit various types of information to presentation device 2 and/or to receive various types of information from presentation device 2. Moreover, communicator 11 wirelessly communicates with one or more robots 3 via network N1, so as to transmit various types of information to one or more robots 3 and/or to receive various types of information from one or more robots 3.

Processor 12 includes, for example, a processor and a memory, and causes the processor to execute a program stored in the memory, so as to exhibit various types of functions included in server 1. In the embodiment, processor 12 includes first acquirer 121, second acquirer 122, identifier 123, and output unit 124.

First acquirer 121 acquires user information including the position of user 40. First acquirer 121 is responsible for executing a process for acquiring user information. In the embodiment, first acquirer 121 receives information indicating the position of smart glasses 20 (i.e., the position of user 40) from smart glasses 20 via communicator 11, so as to acquire user information. For example, the information indicating the position of smart glasses 20 can be acquired by performing positioning using a positioning system, such as a Global Positioning System (GPS), provided in smart glasses 20.

For example, first acquirer 121 may acquire at least one detection result transmitted from at least one human sensor, disposed at the worksite, via communicator 11, and calculate the position of user 40 based on the at least one detection result acquired.

Furthermore, first acquirer 121 (i.e., in the process for acquiring user information) may further acquire posture information indicating a posture of user 40. The posture of user 40 may include, for example, a standing posture of user 40, a sitting posture of user 40, a posture in which user 40 is about to stand up, a posture in which user 40 is performing work, such as carrying an object, or the like.

For example, first acquirer 121 may acquire a captured image of user 40 and use an appropriate image analysis algorithm or machine-learned model on the acquired image, so as to detect multiple feature points, such as the body, arms, legs, and joints, of user 40 and estimate the posture of user 40 based on the multiple detected feature points. For example, the captured image of user 40 can be acquired by capturing user 40 with a camera disposed at the worksite and receiving the image transmitted from the camera via communicator 11.

Furthermore, first acquirer 121 (i.e., in the process for acquiring user information) may further acquire directional information indicating at least one of the direction of the face or the direction of the line of sight of user 40. For example, first acquirer 121 may acquire a captured image of user 40 and use an appropriate image analysis algorithm or machine-learned model on the acquired image, so as to detect multiple facial feature points, such as the eyes, nose, and mouth, in the facial region of user 40, and estimate the direction of the face of user 40 based on the multiple detected facial feature points. Moreover, for example, first acquirer 121 may estimate the direction of the line of sight of user 40 based on a combination of the estimated direction of the face and the direction of the pupils in the detected eyes.

Second acquirer 122 acquires robot information including the position of each of one or more robots 3. Second acquirer 122 is responsible for executing a process for acquiring robot information. In the embodiment, second acquirer 122 acquires robot information by receiving, from each of one or more robots 3 via communicator 11, information indicating the position of robot 3. For example, the information indicating the position of robot 3 can be acquired by performing positioning using a positioning system, such as GPS, provided in robot 3.

For example, second acquirer 122 may acquire at least one detection result transmitted from at least one human sensor, disposed at the worksite, via communicator 11, and calculate the position of each of one or more robots 3 based on the at least one detection result acquired.

Furthermore, second acquirer 122 (i.e., in the process for acquiring robot information) may further acquire behavior information indicating the behavior of each of one or more robots 3. For example, behavior information may include work details to be executed by each of one or more robots 3, a planned movement path along which each of one or more robots 3 is to travel, or the like. For example, behavior information may be acquired from each of one or more robots 3 by communicating with each of one or more robots 3 via communicator 11, or may be acquired from a management system by communicating with the management system, which manages one or more robots 3, via communicator 11.

When one or more robots 3 include an autonomous flying robot (second robot 32), second acquirer 122 (i.e., in the process for acquiring robot information) may further acquire height information indicating the height of the autonomous flying robot. For example, second acquirer 122 can acquire height information by communicating with second robot 32 via communicator 11 and receiving information indicating the position of second robot 32 measured by a positioning system provided in second robot 32.

Furthermore, when one or more robots 3 include a robot (third robot 33) including a manipulator, second acquirer 122 (i.e., in the process for acquiring robot information) may further acquire movable range information indicating the movable range of the manipulator. For example, second acquirer 122 can acquire movable range information by communicating with third robot 33 via communicator 11 and receiving movable range information stored in third robot 33.

Based on the user information acquired by first acquirer 121 and the robot information acquired by second acquirer 122, identifier 123 identifies at least one candidate robot 30 (see FIG. 3 and the like) that is a candidate to which user 40 is to pay attention. Identifier 123 is responsible for executing a process for identifying at least one candidate robot 30. Candidate robot 30 is robot 3 to which user 40 is recommended to pay attention. Thus, user 40 does not have to pay attention to candidate robot 30.

In the embodiment, identifier 123 (i.e., in the process for identifying at least one candidate robot 30) determines at least one zone A1 with reference to the position of user 40, and identifies robot 3 present within at least one determined zone A1 as candidate robot 30. For example, at least one zone A1 is a concentric circular area centered on the position of user 40 in plan view. An example of the process for identifying at least one candidate robot 30 by identifier 123 will be described below.

FIG. 3 is a schematic diagram illustrating an example of the process for identifying at least one candidate robot 30. FIG. 3 illustrates a state where multiple robots 3 and multiple workers 4 including user 40 coexist at the worksite. The same state is also illustrated in FIG. 4 to be described later. In the example illustrated in FIG. 3, user 40 is stationary and is performing work while facing a southern wall. In this case, identifier 123 determines not to set at least one zone A1 based on user information indicating that user 40 is stationary. In other words, in this case, identifier 123 does not identify any of robots 3 as candidate robot 30.

FIG. 4 is a schematic diagram illustrating another example of the process for identifying at least one candidate robot 30. In the example illustrated in FIG. 4, user 40 is moving in the northeast direction. The arrow in FIG. 4 indicates the direction in which user 40 is moving. In this case, identifier 123 determines at least one zone A1 (in this case, first zone A11 and second zone A12) centered on the position of user 40 based on user information indicating that user 40 is moving.

First zone A11 is a circular area having a first radius and centered on the position of user 40 in plan view. Second zone A12 is a circular area having a second radius (>first radius) and centered on the position of user 40 in plan view, and excluding first zone A11. In the example illustrated in FIG. 4, robot 3 present near user 40 is located within second zone A12. Thus, identifier 123 identifies relevant robot 3 as candidate robot 30.

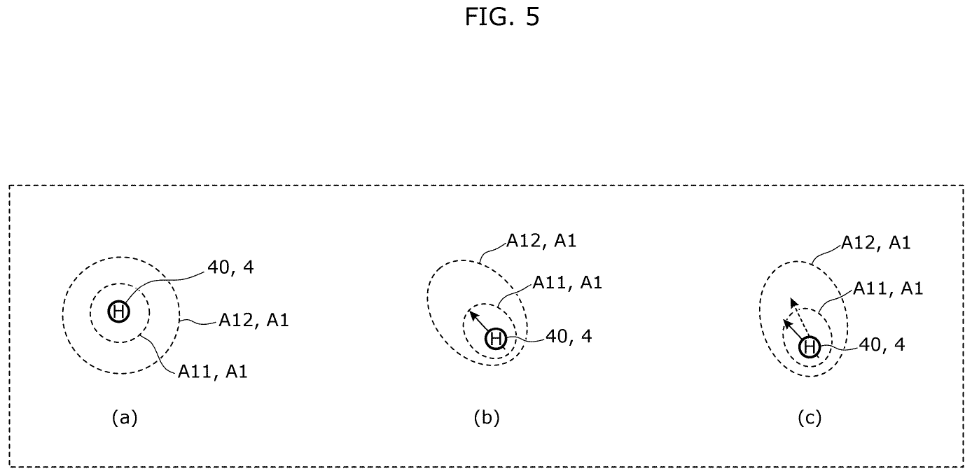

An example of a process for determining at least one zone A1 by identifier 123 will be described below. FIG. 5 is a schematic diagram illustrating an example of the process for determining at least one zone A1 (in this case, first zone A11 and second zone A12).
(a) of FIG. 5 illustrates at least one zone A1 determined based on the position of user 40. The example illustrated in (a) of FIG. 5 is similar to the example illustrated in FIG. 4 in that first zone A11 and second zone A12 are concentric circular areas centered on the position of user 40 in plan view. Identifier 123 may determine at least one zone A1 based only on the position of user 40 in this manner.
(b) of FIG. 5 illustrates at least one zone A1 determined based on the direction in which user 40 moves. In (b) of FIG. 5, the solid arrow indicates the direction in which user 40 moves. In the example illustrated in (b) of FIG. 5, first zone A11 and second zone A12 are both elliptical areas whose major axes are elongated in the direction in which user 40 moves. In this manner, identifier 123 may determine at least one zone A1 based not only on the position of user 40 but also on the direction in which user 40 moves.
(c) of FIG. 5 illustrates at least one zone A1 determined based on the direction of the face (or the direction of the line of sight) of user 40. In (c) of FIG. 5, the solid arrow indicates the direction in which user 40 moves, and the dashed arrow indicates the direction of the face (or the direction of the line of sight) of user 40. In the example illustrated in (c) of FIG. 5, first zone A11 and second zone A12 are both elliptical areas whose major axes are elongated in the direction of the face (or the direction of the line of sight) of user 40. In this manner, identifier 123 may determine at least one zone A1 based not only on the position of user 40 but also on the direction of the face (or the direction of the line of sight) of user 40.

In other words, identifier 123 (i.e., in the process for identifying at least one candidate robot 30) may determine at least one zone A1 further based on acquired directional information. For example, when at least one robot 3 exists in the direction of the face (or the direction of the line of sight) of user 40 indicated by the directional information, identifier 123 can determine at least one zone A1 even if the user information indicates that user 40 is stationary. This aspect is advantageous in that, since robot 3 that cannot be captured when at least one zone A1 is determined based on user information alone can be identified as candidate robot 30, robot 3 that may be a target of the attention of user 40 can be identified readily and accurately.

When first acquirer 121 has acquired posture information, identifier 123 (i.e., in the process for identifying at least one candidate robot 30) may determine at least one zone A1 further based on the acquired posture information. For example, when the posture information indicates that user 40 is in a posture for taking one step forward, identifier 123 can determine at least one zone A1 from a time point prior to the time point at which the start of movement by user 40 is determined based on user information. This aspect is advantageous in that, since at least one zone A1 can be determined sooner than when at least one zone A1 is determined based on user information alone, user 40 can quickly and accurately ascertain information about robot 3 that may be a target of the attention of user 40.

When second acquirer 122 has acquired behavior information, identifier 123 (i.e., in the process for identifying at least one candidate robot 30) may identify at least one candidate robot 30 further based on the acquired behavior information. For example, when the movement path of robot 3 indicated by the behavior information is a path extending through at least one zone A1, identifier 123 may identify relevant robot 3 as candidate robot 30 at a time point at which relevant robot 3 is not present in at least one zone A1. Furthermore, for example, when the work details of robot 3 indicated by the behavior information are related to user 40, identifier 123 may identify relevant robot 3 as candidate robot 30 at a time point at which relevant robot 3 is not present in at least one zone A1. This aspect is advantageous in that, since at least one candidate robot 30 can be identified sooner than when at least one candidate robot 30 is identified based on user information alone, user 40 can quickly and accurately ascertain information about robot 3 that may be a target of the attention of user 40.

When second acquirer 122 has acquired height information, identifier 123 (i.e., in the process for identifying at least one candidate robot 30) may identify at least one candidate robot 30 further based on the acquired height information. For example, when an autonomous flying robot (second robot 32) exists in at least one zone A1, identifier 123 compares the height of second robot 32 indicated by the height information with a predetermined height set in advance. Then, identifier 123 identifies second robot 32 as candidate robot 30 if the height of second robot 32 is below the predetermined height, or does not identify second robot 32 as candidate robot 30 if the height of second robot 32 is above the predetermined height. This aspect is advantageous in that, since candidate robot 30 can be identified in view of the height of the autonomous flying robot (second robot 32), user 40 can readily and accurately identify robot 3 that may be a target of the attention of user 40.

When second acquirer 122 has acquired movable range information, identifier 123 (i.e., in the process for identifying at least one candidate robot 30) may identify at least one candidate robot 30 further based on the acquired movable range information. For example, even when the position of a robot (third robot 33) including a manipulator indicated by robot information is outside at least one zone A1, if the movable range of the manipulator of third robot 33 indicated by the movable range information overlaps at least one zone A1, identifier 123 identifies relevant third robot 33 as candidate robot 30. This aspect is advantageous in that, since candidate robot 30 can be identified in view of the movable range of the manipulator of the robot (third robot 33) including the manipulator, user 40 can readily and accurately identify robot 3 that may be a target of the attention of user 40.

Output unit 124 outputs notification information. Output unit 124 is responsible for executing a process for outputting notification information. Notification information includes at least one of information for prompting attention to at least one candidate robot 30 identified by identifier 123, information indicating the position of at least one candidate robot 30, or information indicating the movement of at least one candidate robot 30. In the embodiment, output unit 124 outputs the notification information by transmitting the notification information to presentation device 2 (smart glasses 20) via communicator 11. An example of the process for outputting notification information by output unit 124 will be described below.

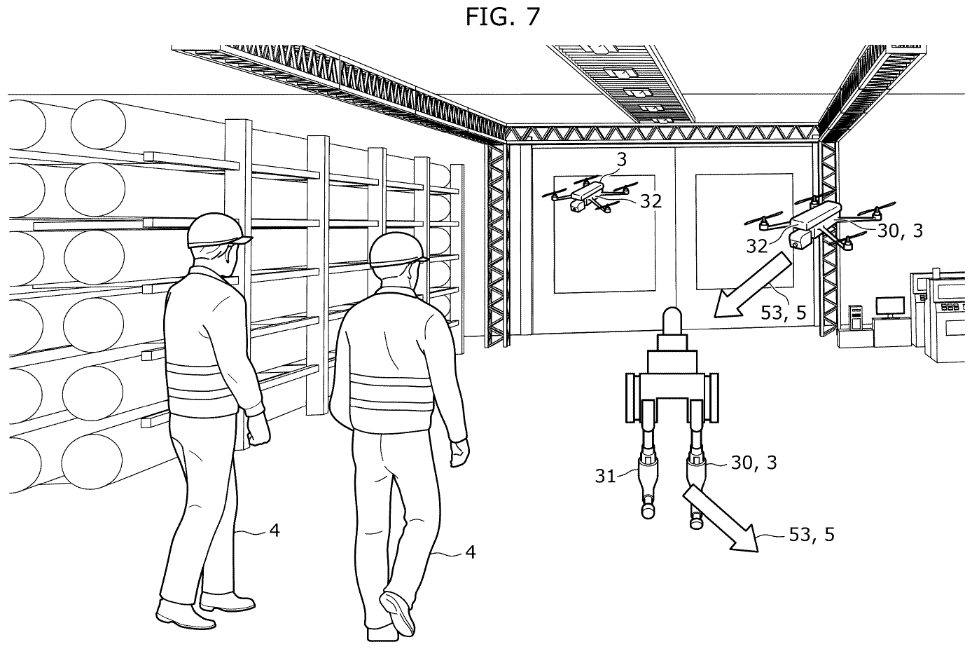

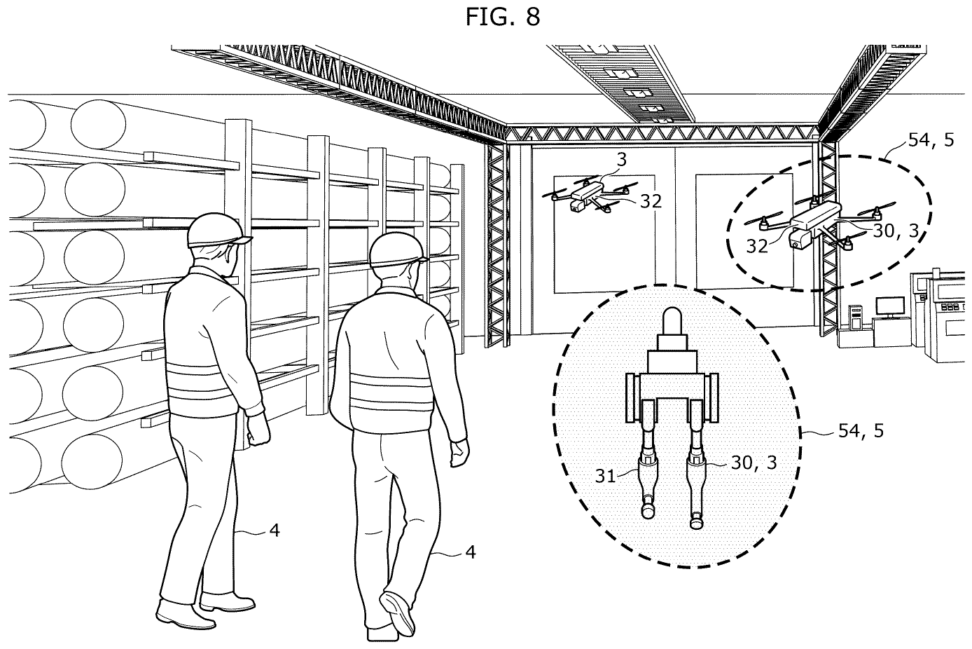

FIG. 6 is a schematic diagram illustrating a first example of notification information presented on presentation device 2 (smart glasses 20). FIG. 6 illustrates the visual field of user 40 on presenter 23 (i.e., the display of smart glasses 20). FIG. 7 and FIG. 8, to be described later, also illustrate the visual field of user 40 on presenter 23.

As illustrated in FIG. 6, the first example corresponds to a state where there are two workers 4, one autonomous mobile robot (first robot 31), and two autonomous flying robots (second robots 32) in the visual field of user 40 on presenter 23. The first example corresponds to a state where one first robot 31 and near-side second robot 32 of two second robots 32 are identified as candidate robots 30. A second example and a third example, to be described later, also correspond to a similar state.

As illustrated in FIG. 6, in the first example, multiple notification objects 5 (in this case, two first notification objects 51 and two second notification objects 52) as notification information are displayed in the visual field of user 40 on presenter 23 in a superimposed fashion.

Two first notification objects 51 are both exclamation marks and are information indicating the positions of candidate robots 30 to user 40 and also prompting user 40 to pay attention to candidate robots 30. Two first notification objects 51 are displayed in proximity to first robot 31 and in proximity to near-side second robot 32, respectively.

Two second notification objects 52 are both text strings indicating the speeds of candidate robots 30 and are information indicating the positions of candidate robots 30 to user 40 and also indicating the movements of candidate robots 30 to user 40. Two second notification objects 52 are displayed in proximity to first robot 31 and in proximity to near-side second robot 32, respectively. For example, the speed of each candidate robot 30 can be estimated based on an amount of change in the position of candidate robot 30 indicated by robot information. The speed of each candidate robot 30 can also be acquired by, for example, receiving, via communicator 11, a detection result of a speed sensor provided in candidate robot 30.

In the first example, user 40 can readily pay attention to first robot 31 and near-side second robot 32 by viewing two first notification objects 51. Moreover, user 40 can ascertain the movement speeds of first robot 31 and near-side second robot 32 by viewing two second notification objects 52.

FIG. 7 is a schematic diagram illustrating a second example of notification information presented on presentation device 2 (smart glasses 20). As illustrated in FIG. 7, in the second example, multiple notification objects 5 (i.e., two third notification objects 53) as notification information are displayed in the visual field of user 40 on presenter 23 in a superimposed fashion.

Two third notification objects 53 are both arrows indicating the movement directions of candidate robots 30 and are information indicating the positions of candidate robots 30 to user 40 and also indicating the movements of candidate robots 30 to user 40. Moreover, two third notification objects 53 are both information indicating the movement directions (or the movement paths) of candidate robots 30. Two third notification objects 53 are displayed in proximity to first robot 31 and in proximity to near-side second robot 32, respectively.

In the second example, user 40 can readily pay attention to first robot 31 and near-side second robot 32 by viewing two third notification objects 53. Moreover, by viewing two third notification objects 53, user 40 can ascertain how first robot 31 and near-side second robot 32 move. In other words, the second example is advantageous in that information indicating how each robot 3 (i.e., at least one candidate robot 30), which may be a target of the attention of user 40, moves can be presented to user 40, so that user 40 can pay attention to relevant robot 3 more readily.

FIG. 8 is a schematic diagram illustrating a third example of notification information presented on presentation device 2 (smart glasses 20). As illustrated in FIG. 8, in the third example, multiple notification objects 5 (in this case, two fourth notification objects 54) as notification information are displayed in the visual field of user 40 on presenter 23 in a superimposed fashion.

Two fourth notification objects 54 are both circles surrounding candidate robots 30 and are information indicating the positions of candidate robots 30 to user 40 and also prompting user 40 to pay attention to candidate robots 30. Two fourth notification objects 54 are displayed over first robot 31 and near-side second robot 32, respectively, in a superimposed fashion.

In the third example, first robot 31 exists in first zone A11, and near-side second robot 32 exists in second zone A12. Therefore, in the third example, fourth notification object 54 superimposed on first robot 31 is highlighted more than fourth notification object 54 superimposed on near-side second robot 32.

In the third example, user 40 can readily pay attention to first robot 31 and near-side second robot 32 by viewing two fourth notification objects 54. Moreover, by viewing highlighted fourth notification object 54 of two fourth notification objects 54, user 40 can ascertain that particular attention should be paid to first robot 31 between first robot 31 and near-side second robot 32.

Memory 13 is a dedicated or general purpose memory for storing information in information processing system 100. Memory 13 may be an electrical circuit. Memory 13 may be a magnetic disk, an optical disk, or the like, and/or may also be expressed as storage or a recording medium. Memory 13 may be a nonvolatile memory or a volatile memory. Memory 13 may include processor 12. For example, memory 13 may store information to be used for information processing by processor 12, and/or may store a program to be used for performing information processing by processor 12.

### 2. Operation

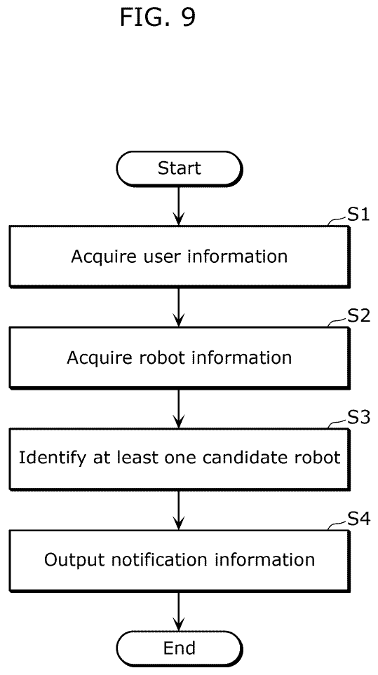

The operation of information processing system 100 according to the embodiment, that is, an information processing method, will be described below. FIG. 9 is a flowchart illustrating a basic operation example of information processing system 100 according to the embodiment. The following description is based on an assumption that step S1 to step S4 illustrated in FIG. 9 are repeatedly executed for every processing unit time.

First, when the operation of information processing system 100 starts, first acquirer 121 acquires user information (S1). Second acquirer 122 acquires robot information (S2). Step S1 and step S2 may be executed in reverse order. Step S1 and step S2 may be executed concurrently.

Subsequently, identifier 123 identifies at least one candidate robot 30 based on the user information acquired by first acquirer 121 and the robot information acquired by second acquirer 122 (S3). In step S3, identifier 123 may identify at least one candidate robot 30 further based on information, such as behavior information, posture information, directional information, height information, or movable range information mentioned above, different from the user information and the robot information.

Then, output unit 124 outputs notification information (S4). In step S4, output unit 124 transmits the notification information to smart glasses 20 (presentation device 2) via communicator 11, thereby outputting the notification information. When receiving the notification information via communicator 21, presenter 23 of smart glasses 20 presents the received notification information to user 40. Accordingly, user 40 can ascertain information about robot 3 (at least one candidate robot 30) that may be a target of the attention of user 40.

### 3. Advantage

The advantage of information processing system 100 (information processing method) according to the embodiment will be described below. For example, when information about all robots 3 present in the visual field of user 40 is displayed on the display of smart glasses 20 worn by user 40, a problem may occur where user 40 is exposed to an excessive amount of information and may find it difficult to ascertain robot 3 that should to be paid attention to.

In contrast, information processing system 100 according to the embodiment can present only information about at least one candidate robot 30 to user 40 instead of presenting information about all robots 3 present around user 40. Therefore, information processing system 100 according to the embodiment is advantageous in that user 40 can readily ascertain information about robot 3 (at least one candidate robot 30) that may be a target of the attention of user 40.

### Other Embodiments

Although the embodiment has been described above, the present disclosure is not limited to the above embodiment.

Presentation device 2 is a pair of smart glasses 20 in the above embodiment, but is not limited thereto. For example, presentation device 2 may be a goggle-type head mounted display or a headset such as a mixed reality (MR) headset. Presenter 23 of presentation device 2 is not limited to a transmissive display, and may be a non-transmissive display. In this case, presenter 23 may display an image of the real space captured by a camera provided in presentation device 2. Presentation device 2 is not limited to a head mounted display, and may be a portable terminal, such as a smartphone or a tablet terminal. In this case, user 40 may cause presenter 23 to display the front side of user 40 by holding presentation device 2 in front of user 40.

For example, presenter 23 of presentation device 2 may present, to user 40, notification information by outputting audio from a loudspeaker provided in presentation device 2. In this case, presenter 23 may output audio that enables user 40 to perceive that, for example, a warning sound or a message, such as “robot 3 is approaching”, has been released from candidate robot 30.

For example, presentation device 2 may be a device that outputs audio alone from earphones, headphones, or the like worn by user 40. In this case, similar to the above, presenter 23 of presentation device 2 may output audio that enables user 40 to perceive that, for example, a warning sound or a message, such as “robot 3 is approaching”, has been released from candidate robot 30.

For example, presentation device 2 may be a relatively large display disposed at the worksite. In this case, for example, processor 12 of information processing system 100 may determine whether the face (or the line of sight) of user 40 is directed toward the display based on acquired user information or directional information. Then, for example, if the face (or the line of sight) of user 40 is determined to be directed toward the display, output unit 124 may cause the display to display notification information.

Furthermore, for example, the information processing system described in the above embodiment may be realized as a single device (e.g., a server) including all of the elements, or may be realized by allocating functions to multiple devices and causing the multiple devices to operate in cooperation with each other.

In the above embodiment, a process executed by a specific processor may be executed by a different processor. Furthermore, the order of multiple processes may be changed, and/or multiple processes may be executed concurrently.

Each of the elements in the above-described embodiments may be realized by executing a software program suitable for the element. Each of the elements may be realized by means of a program executer, such as a central processing unit (CPU) or a processor, reading and executing a software program recorded on a recording medium, such as a hard disk or a semiconductor memory.

Each of the elements may be realized by hardware. For example, each element may be a circuit (or an integrated circuit). These circuits may be configured as a single circuit as a whole, or may be separate circuits. These circuits may be general purpose circuits or may be dedicated circuits.

The general or specific aspects of the present disclosure may be implemented using a device, a method, an integrated circuit, a computer program, or a non-transitory computer readable recording medium, such as a CD-ROM. The general or specific aspects of the present disclosure may be implemented using any combination of devices, methods, integrated circuits, computer programs, and recording media.

For example, the present disclosure may be implemented as an information processing method executed by a computer, or may be implemented as a program for causing the computer to execute the information processing method. The present disclosure may be implemented as a non-transitory computer readable recording medium having such a program recorded thereon.

The present disclosure also encompasses an embodiment obtained by applying each type of variation conceivable by a skilled person to each embodiment, or an embodiment obtained by arbitrarily combining elements and functions in each embodiment within a range not departing from the scope of the present disclosure.

### Industrial Applicability

The present disclosure is useful when presenting robot related information to users.

1. An information processing method executed by a computer, the information processing method comprising:
acquiring user information including a position of a user;
acquiring robot information including a position of at least one robot;
identifying at least one candidate robot based on the user information acquired and the robot information acquired, the at least one candidate robot being a candidate to which the user is to pay attention; and
outputting notification information including at least one of information prompting attention to the at least one candidate robot identified, information indicating a position of the at least one candidate robot, or information indicating a movement of the at least one candidate robot.

2. The information processing method according to claim 1, wherein
the information indicating the movement of the at least one candidate robot includes at least one of a movement direction or a movement path of the at least one candidate robot.

3. The information processing method according to claim 1, wherein
the identifying of the at least one candidate robot includes:
determining at least one zone with reference to the position of the user; and
identifying, as the at least one candidate robot, a robot present in the at least one zone determined.

4. The information processing method according to claim 3, wherein
the acquiring of the robot information includes further acquiring behavior information indicating a behavior of the at least one robot, and
in the identifying of the at least one candidate robot, the at least one candidate robot is identified further based on the behavior information acquired.

5. The information processing method according to claim 3, wherein
the acquiring of the user information includes further acquiring posture information indicating a posture of the user, and
in the identifying of the at least one candidate robot, the at least one zone is determined further based on the posture information acquired.

6. The information processing method according to claim 3, wherein
the acquiring of the user information includes further acquiring directional information indicating at least one of a direction of a face or a direction of a line of sight of the user, and
in the identifying of the at least one candidate robot, the at least one zone is determined further based on the directional information acquired.

7. The information processing method according to claim 1, wherein
the at least one robot includes an autonomous flying robot,
the acquiring of the robot information includes further acquiring height information indicating a height of the autonomous flying robot, and
in the identifying of the at least one candidate robot, the at least one candidate robot is identified further based on the height information acquired.

8. The information processing method according to claim 1, wherein
the at least one robot includes a robot including a manipulator,
the acquiring of the robot information includes further acquiring movable range information indicating a movable range of the manipulator, and
in the identifying of the at least one candidate robot, the at least one candidate robot is identified further based on the movable range information acquired.

9. The information processing method according to claim 1, wherein
in the outputting of the notification information, the notification information is output to smart glasses worn by the user.

10. A non-transitory computer-readable recording medium having recorded thereon a program for causing a computer to execute the information processing method according to claim 1.

11. An information processing system comprising:
a first acquirer that acquires user information including a position of a user;
a second acquirer that acquires robot information including a position of at least one robot;
an identifier that identifies at least one candidate robot based on the user information acquired by the first acquirer and the robot information acquired by the second acquirer, the at least one candidate robot being a candidate to which the user is to pay attention; and
an output unit that outputs notification information including at least one of information prompting attention to the at least one candidate robot identified by the identifier, information indicating a position of the at least one candidate robot, or information indicating a movement of the at least one candidate robot.

12. The information processing system according to claim 11, further comprising:
a presentation device including a communicator and a presenter, the communicator receiving the notification information output by the output unit, the presenter presenting, to the user, the notification information received by the communicator.
